(19) United States
(12) Patent Application Publication
(10) Pub. No.: US 2025/0187244 A1
(43) Pub. Date: Jun. 12, 2025

(54) METHOD FOR ROTATING A ROTATABLE PART

(71) Applicant: ARBURG GMBH + CO KG, Lossburg (DE)

(72) Inventor: Werner FAULHABER, Loßburg Wittendorf (DE)

(21) Appl. No.: 18/702,350

(22) PCT Filed: Oct. 19, 2022
(86) PCT No.: PCT/EP2022/079052

§ 371 Date: Nov. 11, 2024

(30) Foreign Application Priority Data
Oct. 20, 2021 (DE) 10 2021 127 214.9

(51) Int. Cl. B29C 45/80; B29C 45/04

(52) U.S. Cl. CPC B29C 45/80; B29C 45/0441; B29C 2045/0491; B29C 2945/76578; B29C 2945/76732; B29C 2945/76949

(57) ABSTRACT

In a method for rotating a rotatable part (16) about at least one axis of rotation of a machine (10) for processing plastics and other plasticizable masses, in particular an injection-moulding machine having at least one movable segment (14) for producing at least one moulding, in order to optimize the movements of the machine (10), in particular the tool movements, and to save cycle time, but still with safe, gentle and low-wear operation, the movement of the at least one segment (14) is at least partially superimposed with the movement of the rotatable part (16), wherein the movement of the rotatable part (16) is started when the distance between the at least one segment (14) and the rotatable part (16) is greater than a moulding height of a moulding to be produced on the machine (10).

### REFERENCE TO RELATED APPLICATIONS

The present invention relates to and claims priority from German patent application 10 2021 127 214.9, filed on 20 Oct. 2021, the disclosure of which is also explicitly incorporated into the subject matter of the present application in its entirety.

### FIELD OF THE INVENTION

The present invention is in the field of molds and machines for processing plastics and other plasticizable materials, in particular in the field of injection molding machines. The invention relates to a method for rotating at least one part about at least one axis of rotation, according to the preamble of claim 1, to a machine according to the preamble of claim 12, and to a computer program product according to the preamble of claim 13.

Where, in the course of this application, mention is made of a “molded part”, this is an injection molded part that is molded and hence manufactured, partly or entirely, in a mold cavity of a mold of a machine for processing plastics and other plasticizable materials, or a molding that is molded or manufactured in this way. These terms can be used synonymously.

### PRIOR ART

Machines that are for processing plastics and other plasticizable materials and which have one or more rotatable parts, such as a center section, a cube, a mold or a cube mold that are used to manufacture molded parts, are known from the prior art. For example, systems for the optimized operation of a cube mold on injection molding machines are known. Cube molds typically comprise three mold segments: a first segment that has for example a mold that is secured to a movable platen; a second segment that has a mold secured to a fixed platen; and a third segment or the rotatable part, such as a cube, which is square in plan view (hence the name “cube mold”) and which has a vertical axis of rotation at the point of intersection of the diagonals as seen in plan view. The first segment may be moved along a linear axis, for example using the movable platen. The third segment or cube is mounted rotatably and may be secured to a slidable table. The slidable table may be moved linearly along an axis. The two linear movements of the movable platen and the slidable table are typically parallel to one another. The cube may be rotated for example in four steps, each by 90°, into the positions A, B, C and D. In this way, the cube face A points for example in the direction of the second segment. After being rotated twice (by a total of 180°), this cube face A then points in the direction of the first segment. As an alternative, the cube may also be rotated by 180°, in which case the cube is only provided with cavities on two sides. In special cases, the cube may also be divided in the horizontal plane, into an upper and a lower cube half which may be rotated separately from one another by two drives. In this way, the upper and lower cube halves may also be rotated in different directions.

Functioning of the mold movements is described below with reference to an ongoing process. The mold is in the closed position, that is to say that the cube forms a mold cavity 2A, for example with the cube face A and the second segment (fixed platen). On the opposite side, the cube face C forms a mold cavity 1C with the first segment (movable platen). Typically, a respective plasticizable melt is injected into the two mold cavities 2A and 1C simultaneously, through two injection units. The force applied by way of the movable platen forms the closing force acting on the mold. Once the molded parts reach a state in which they are demoldable, the first segment is opened by way of the movable platen. After a previously set delay time, the slidable table is displaced, with the axis of rotation of the cube segment, to a position in which the cube can be rotated without a collision. At this point, the cube can rotate by at least 90°. Typically, rotation is either in one direction or alternating.

CH 707 711 A2 discloses a retaining device for a rotatable mold center section in an injection molding machine. A plate that is rotatable about an axis of rotation and driven by way of a motor serves to retain the rotatable mold center section. The retaining device comprises a lower cross member, which is mounted displaceably in the longitudinal direction on guide rails while supported on a machine bed of the injection molding machine by way of first bearing blocks. Further, the retaining device comprises second bearing blocks by way of which the lower cross member is supported in the circumferential direction relative to lower beams of the injection molding machine.

WO 2019/029984 A1 discloses a mounting device for mold parts of an injection molding tool, wherein the tool is mounted on top of a mounting plate that is inserted into the injection molding machine and where necessary can also be removed therefrom, wherein a guiding system can be used to perform a translational shift of the mounting plate.

### SUMMARY OF THE INVENTION

Taking this prior art as a starting point, the object of the present invention is to provide a method for rotating a rotatable part about at least one axis of rotation of a machine for processing plastics and other plasticizable materials, in particular an injection molding machine, wherein the method optimizes the movements of the machine, in particular the mold movements, and saves on cycle time and nonetheless operates securely, gently and with low wear.

This object is achieved by a method for rotating a rotatable part of a machine for processing plastics and other plasticizable materials, in particular an injection molding machine, comprising the features of claim 1, a machine comprising the features of claim 12, and a computer program product comprising the features of claim 13.

Advantageous further developments form the subject matter of the dependent claims. The features that are specified individually in the claims are combinable where this is technologically meaningful, and may be supplemented by explanatory information from the description and details from the Figures, with further variant embodiments of the invention being indicated.

In a method for rotating a rotatable part, such as a center section, a cube, a mold or a cube mold, about at least one axis of rotation of a machine for processing plastics and other plasticizable materials, in particular an injection molding machine, having at least one movable segment, such as a movable mold clamping plate, a movable platen, a movable mold segment or a movable tool segment, for the manufacture of at least one molded part, movement of the at least one segment is at least partly overlapped by movement of the rotatable part, wherein movement of the rotatable part is started when the spacing between the at least one segment and the rotatable part is greater than a molded part height of a molded part that is to be manufactured on the machine. The molded part height corresponds to the dimension by which the preferably completely demolded molded part projects out of the rotatable part. Advantageously, in this way there is a saving on time in respect of the cycle time, while nonetheless ensuring security in respect of collision of the part.

The rotatable part, such as a center section, a cube, a mold or a cube mold, is provided, configured and set up to rotate and/or turn. Further, however, the rotatable part may also perform any desired combination of a rotary movement, a turning movement, a linear movement and/or a translational movement. For example, the rotary movement or the turning movement of the rotatable part may be performed counter-clockwise and/or clockwise, and the linear movement and/or the translational movement of the rotatable part may be performed horizontally and/or vertically.

Preferably, the movement of the rotatable part is a rotary movement and/or a turning movement. Further preferably, the movement of the rotatable part may also be any desired combination of a rotary movement, a turning movement, a linear movement and/or a translational movement.

Preferably, the rotary movement or the turning movement of the rotatable part is performed about at least one axis of rotation or turning.

Movement of the segment and the rotatable part is preferably carried out at least in part simultaneously. There is no wait until the segment has reached its destination, for example, before the rotatable part is moved, but rather the rotatable part already begins to move while movement of the at least one segment is at least in part still under way.

The movements of the at least one segment and the rotatable part may preferably be performed independently of one another. Advantageously, in this way the movements of the machine, in particular the mold movements, are optimized and there is a saving on cycle time, with the method nonetheless operating securely, gently and with low wear.

Preferably, movement of the at least one segment is performed along a linear axis. For example, the movable platen may be connected by way of a toggle lever drive system, such as a drive spindle having a servo-electrical drive, or a piston having a drive, such as a servo-hydraulic drive.

In principle, it is also conceivable for further segments, such as two segments, to be provided, of which at least one segment is movable, such as a movable platen. For example in the case of two segments, one segment may take the form of a movable and the other a fixed platen. It is likewise possible for two segments to be movable, in which case both segments may for example take the form of movable platens.

In order advantageously to further optimize the cycle time, preferably the rotatable part is mounted on and/or on top of a movable table such as a slidable table, and movement of the table is at least partly overlapped by movement of the at least one segment and/or movement of the rotatable part. The movements of the table, the segment and/or the part are thus carried out at least in part simultaneously. For example, the part carries out its movement and/or begins its movement while the table and/or the segment are simultaneously moving. The movements of the table, the segment and/or the part may preferably be independent of one another. Preferably, movement of the table is performed linearly along an axis. For example, movement of the table may be produced servo-hydraulically and/or servo-electrically by way of a piston system, by way of racks and spindles, or a direct drive. Further preferably, the movements of the table and the segment are substantially parallel to one another. Movement of the at least one segment extends for example in the same direction as movement of the table. It is also conceivable, for example in the case of two movable segments that take the form for example of movable platens, for the table not to move.

Preferably, the movements of the at least one segment, the table and/or the rotatable part are at least partly coupled to one another. For example, movement of the at least one segment may be coupled to the rotatable part, movement of the at least one segment may be coupled to the table, movement of the table may be coupled to the rotatable part, or movement of the at least one segment may be coupled to the table and the rotatable part. The movements of the segment, the table and/or the part are thus preferably dependent on one another. Advantageously, in this way no delay times arise, and the cycle time is shortened, according to the programmed speed. Further advantageously, the mold may thus be operated without risk. If for example the speed of the linear movement in the sequence is changed, the rest of the axial movements are automatically adapted to this change. It is also advantageously unproblematically possible to perform a slow start-up of the mold for the purpose of checking the sequences. Preferably, for example movement of the table is coupled to movement of the segment until an overlapped braking function starts up and slows the table down until it reaches its final position for the corresponding work step. Further preferably, as a result of the coupled movement, the table and/or the rotatable part move/moves away from the segment and where appropriate also from a further segment, for example a fixed or further movable platen. In that case, the growing spacing is preferably identical on both sides.

In order advantageously to avoid a collision between the table and the at least one segment, preferably movement of the table in relation to movement of the at least one segment is multiplied by a factor of less than or equal to one, preferably a factor of 0.1, 0.2, 0.3, 0.4, 0.5, 0.6, 0.7, 0.8, 0.9 or 1.0. Preferably, as a result of its movement the table undergoes a change in position that is multiplied by a factor of less than or equal to one, preferably a factor of 0.5. The table preferably moves more slowly than the segment, such that the part mounted on the table effectively moves away from the segment, such as a movable platen, and where applicable away from a further segment, such as a further movable or fixed platen.

Coupling of the movement of the at least one segment, the movable table and/or the rotatable part is preferably carried out electrically and/or mechanically. For example, movement of the at least one segment could be coupled to movement of the table and the rotatable part by way of a mechanical shaft. An electrical coupling, for example by way of a controller that identifies or knows and accordingly coordinates and/or controls the respective positions of the at least one segment, the table and/or the rotatable part, is also conceivable. Also possible is a mixed coupling, in which for example the coupling between the at least one segment and the table is carried out mechanically, for example by a rack, and the further coupling in respect of the rotatable part is electronic.

In order advantageously to obtain exact and secure movement, preferably movement of the at least one segment, the rotatable part and/or the table is position-controlled. For example, the position control may be carried out using a servo-electrical and/or servo-hydraulic drive such as a direct drive or a piston system. For example, for advantageous opening and rotation of the cube mold, at the time of opening the movable platen is moved first. In this case, cyclically the next position to be approached is predetermined as a setpoint value by way of the position control. This setpoint value is for example that of the linear mold position.

Generally, there is no linear relationship between a drive, such as an angle of rotation of a motor, and a corresponding movement of the at least one segment, the part and/or the table. In order to produce a mold movement that is as fast and efficient as possible, for position control movement of the at least one segment, the rotatable part and/or the table is preferably linked by a mathematical function. Preferably, the mathematical function takes the kinematics of the corresponding drive and/or drives into account. For example, in the case of a servo-electrical drive, the angle of rotation of the motor and the linear movement of the movable platen do not have a linear relationship. In order advantageously to produce movement that is as efficient as possible, the desired pattern of movement is preferably linked by a mathematical function with the kinematics of the drive.

Preferably, movement of the rotatable part in at least one angular position about the axis of rotation is position-controlled along a rotational collision curve, as a result of which advantageously movement is performed as smoothly as possible but nonetheless at maximum acceleration and with a late delay, according to the programmed speed. Further preferably, movement of the rotatable part over the rotational collision curve is strictly coupled to position control of the table and hence, to a secondary extent, to position control of the segment, for example the movable platen. For example, the rotational collision curve can be used to check whether rotation of the rotatable part is possible, as a result of which security is advantageously enhanced.

In order advantageously to produce mold movement that is as fast and efficient as possible, the rotational collision curve is preferably dependent on at least one parameter of the part, such as the edge length of the rotatable part and/or the height of the molded part. Preferably, the rotational collision curve of a cube mold is described by a mathematical function that is for example dependent on the edge length of the cube mold and/or the molded part height.

Preferably, the at least one parameter of the rotatable part, such as the edge length of the rotatable part and/or the molded part height, may be input and/or taught. For example, the parameters may be input into the controller and/or ascertained at the machine. However, it is also possible for the controller to be automatically fed the parameters as a result of the rotatable part that is used. It is also possible for the rotatable part to have the parameters, and for the parameters to be transferred to the machine and/or controller at the time of installing the rotatable part in the machine. If, in this example, the parameters of edge length of the cube mold and molded part height are correctly parameterized, and if the mold, with its segments and the rotatable part in the closed mold, has been reset to zero, then advantageously no collision can occur. Advantageously, this security is present in both automatic and manual operation.

Preferably, the movement of at least one peripheral system, such as a robot system and/or a gripper, is at least partly coupled to movements of the at least one segment, the table and/or the rotatable part. Advantageously, in this way delay times are avoided and the cycle time is shortened. For example, by integrating the controller of a robot system, the movement sequences of the robot system may likewise be coupled to movements of the table and movement of the rotatable part.

The object is also achieved by a machine for processing plastics and other plasticizable materials, in particular an injection molding machine. For advantageous optimization in respect of movements of the machine, in particular mold movements, and a saving on cycle time and an operation that is nonetheless secure, gentle and low on wear, the machine takes a form, is configured and/or is set up to carry out the method described above.

Likewise, the object is achieved by a computer program product. For advantageous optimization in respect of movements of the machine, in particular mold movements, and a saving on cycle time and an operation that is nonetheless secure, gentle and low on wear, the computer program product, with a program code, is stored on a computer-readable medium for the purpose of carrying out the method described above.

Further advantages are apparent from the subclaims and the description below of a preferred exemplary embodiment. The features listed individually in the claims are combinable, where this is technologically meaningful, and may be supplemented by explanatory information from the description and details from the Figures, further variant embodiments of the invention being pointed out.

### BRIEF DESCRIPTION OF THE FIGURES

The invention is explained in more detail below with reference to an exemplary embodiment represented in the attached Figures, in which:

FIGS. 1-5 show schematic illustrations of different movements and positions of the rotatable part with a rotation of 90°,

FIGS. 6-10 show schematic illustrations of different movements and positions of the rotatable part with a rotation of 90°, and

FIGS. 11, 12 are graphs.

### DESCRIPTION OF PREFERRED EXEMPLARY EMBODIMENTS

The invention is now explained in more detail by way of example, with reference to the attached drawings. However, the exemplary embodiments are only examples, which are not intended to restrict the inventive concept to a particular arrangement.

Before the invention is described in detail it should be pointed out that it is not restricted to the respective structural parts of the device and the respective method steps, since these structural parts and method may vary. The terms used here are merely intended to describe particular embodiments and are not used restrictively. Moreover, where the singular or the indefinite article is used in the description or the claims, this also refers to a plurality of these elements unless the overall context unambiguously indicates otherwise.

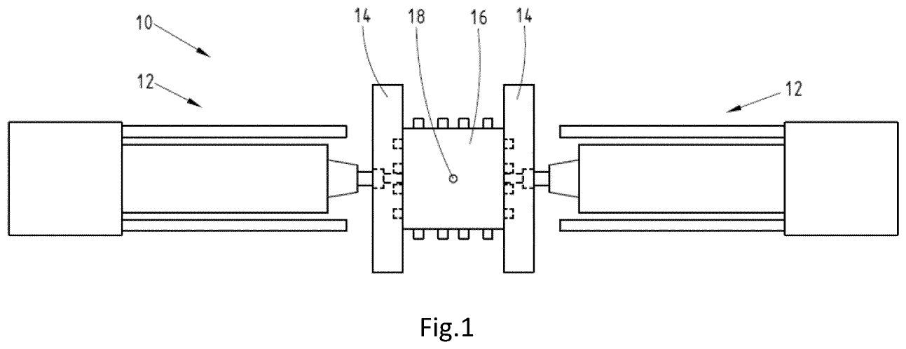

In a first exemplary embodiment, according to FIGS. 1-5, in each case a machine 10 for processing plastics and other plasticizable materials is shown, such as an injection molding machine having two injection units 12 and two segments 14, preferably movable segments 14, each of which for example represents a movable platen, for the manufacture of at least one molded part. Fundamentally, in a further exemplary embodiment it is also conceivable for only one movable segment 14 and/or only one injection unit 12 to be provided. Moreover, in a further exemplary embodiment it is possible for two segments 14 to be provided, wherein for example one segment 14 takes the form of a movable platen and one segment 14 takes the form of a fixed platen. A part 16 that is rotatable about at least one axis 18 of rotation, such as a cube mold, is arranged between the segments 14. In a further exemplary embodiment, the rotatable part 16 may be mounted on and/or on top of a table 30. In a further exemplary embodiment, the table may be movable or, in another further exemplary embodiment, may not move and/or may be fixed.

In FIG. 1, the rotatable part 16 such as the cube mold is in a closed condition. For example, in this condition melt may be injected into the mold through the injection units 12. Once the injection procedure is at an end and/or demoldability of the molded parts is achieved, the cube mold may be rotated about an angle, such as 90°, 180°, 270° or 360°. In principle, the rotatable part 16 may be rotated about any desired angle.

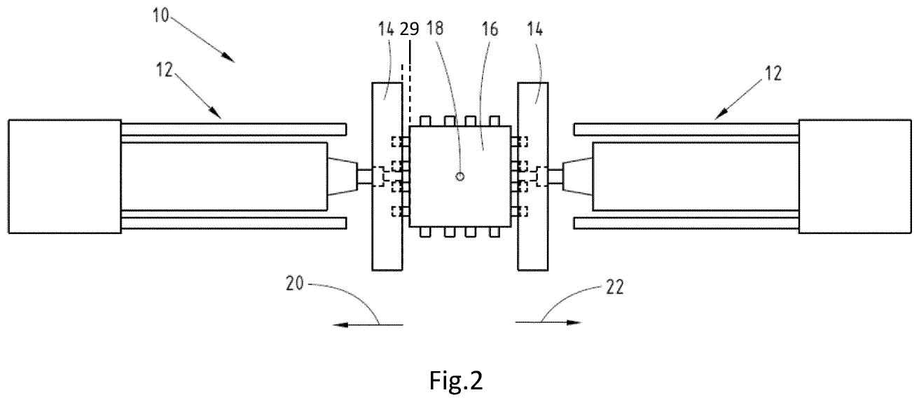

In FIG. 2, the segments 14 are respectively moved in a direction 20, 22. Preferably, the movements are performed in opposite directions 20, 22, for example to left and right. If, in a further exemplary embodiment, there is only one movable segment 14, then movement may fundamentally be performed in any desired direction 20, 22, for example to left or right. Preferably, the movements are performed such that the rotatable part 16 is put into an open condition.

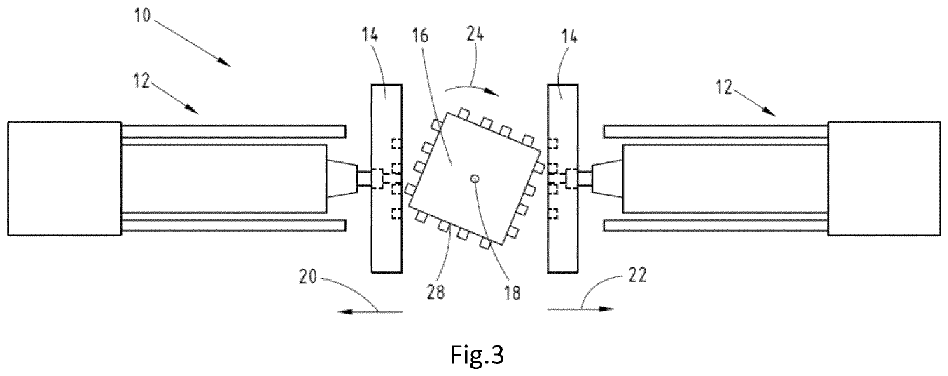

In FIG. 3, movement of the segments 14 is not yet at an end, although movement of the rotatable part 16 is already beginning in a direction 24, for example clockwise rotation. Accordingly, movement of the segments 14 is at least partly overlapped by movement of the rotatable part 16. The rotatable part 16 is already carrying out its movement while movement of the at least one segment 14 is still under way. This advantageously results in optimization in respect of movements of the machine, in particular the mold movements, and a saving on cycle time and an operation that is nonetheless secure, gentle and low on wear.

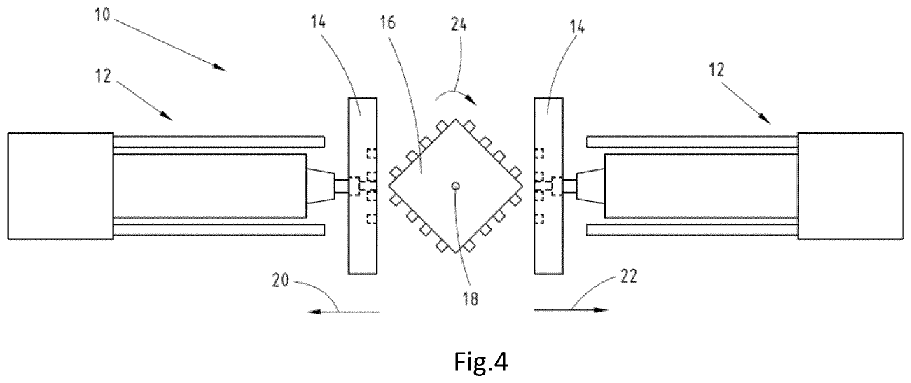

In FIG. 4, the segments 14 move further in the directions 20, 22, and the rotatable part 16 moves further in the direction 24 and rotates.

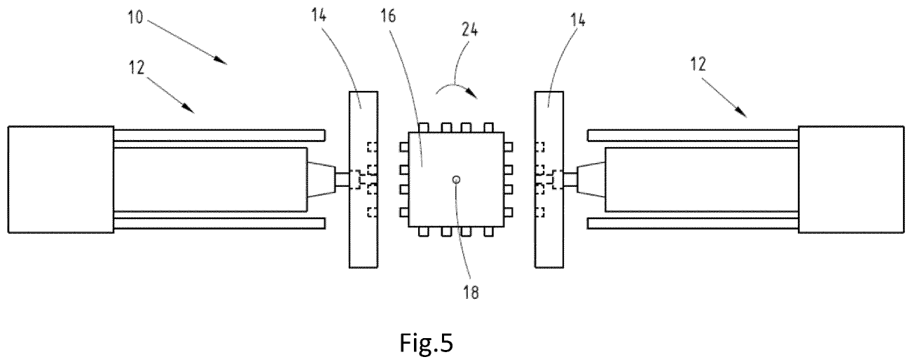

In FIG. 5, the movements of the segments 14 and the rotatable part 16 are at an end. The rotatable part 16 is rotated by 90° in FIG. 5 in relation to the position in FIG. 1. In principle, any desired rotations about any desired axes of rotation and/or angles of rotation are conceivable, for example about 90°, 180°, 270°, 360°, −90°, −180°, −270° or −360°. An alternating operation is likewise also possible.

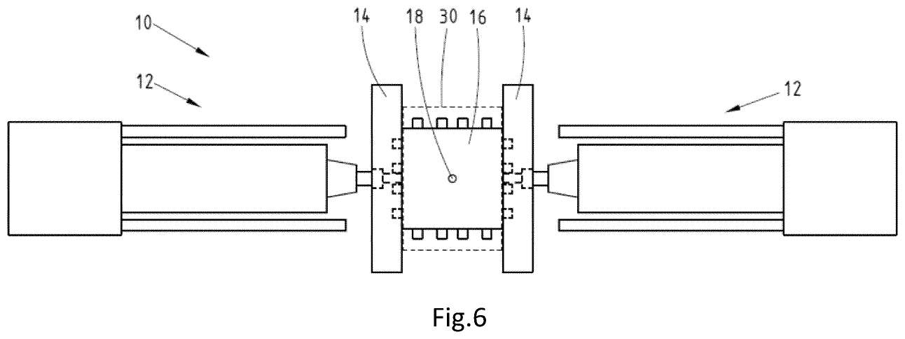

In a further exemplary embodiment, according to FIGS. 6-10, in each case a machine 10 for processing plastics and other plasticizable materials is shown, such as an injection molding machine having two injection units 12 and two movable segments 14, each of which for example represents a movable platen, for the manufacture of at least one molded part. Fundamentally, in a further exemplary embodiment it is also conceivable for only one movable segment 14 and/or only one injection unit 12 to be provided. Moreover, in a further exemplary embodiment it is possible for two segments 14 to be provided, wherein for example one segment 14 takes the form of a movable platen and one segment 14 takes the form of a fixed platen. A part 16 that is rotatable about at least one axis of rotation 18, such as a cube mold, which may be mounted on and/or on top of a table 30, such as a slidable table, is arranged between the segments 14.

In FIG. 6, the rotatable part 16 such as a cube mold is in a closed condition. For example, in this condition melt may be injected into the mold through the injection units 12.

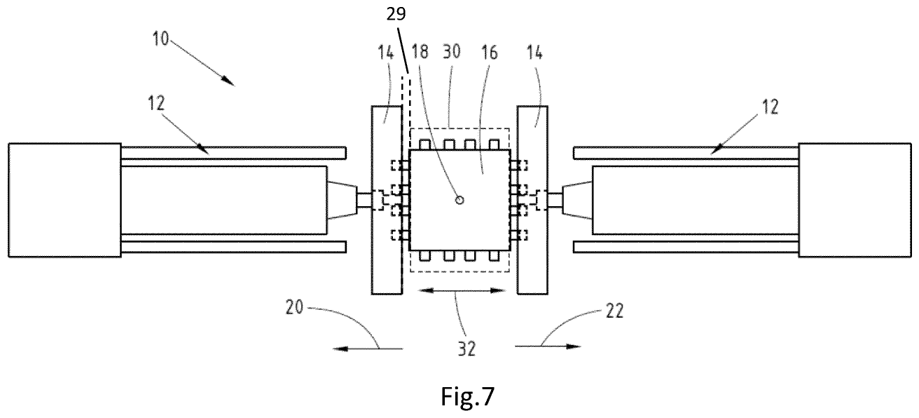

In FIG. 7, the segments 14 are respectively moved in a direction 20, 22. Preferably, the movements are performed in opposite directions 20, 22, for example to left and right. If, in a further exemplary embodiment, there is only one movable segment 14, then movement may fundamentally be performed in any desired direction 20, 22, for example to left or right. FIG. 7 differs from FIG. 2 in that in addition the table 30 is also moved in a direction 32, which is preferably parallel to at least one of the directions 20, 22 of the segment 14, for example to left or right. In FIG. 7, movement of the table 30 is at least partly overlapped by the movement of the segments 14. Fundamentally, however, in another exemplary embodiment it is also conceivable for the segments 14 to move and for the table not to move or to be stationary.

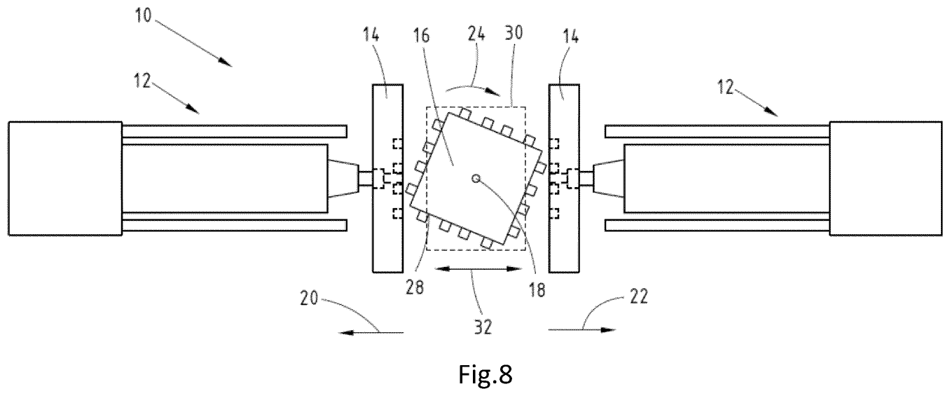

In FIG. 8, in addition to movement of the segments 14 and the table 30, movement of the rotatable part 16 in a direction 24, for example clockwise rotation, also starts up. In FIG. 8, movement of the table 30 is at least partly overlapped by movement of the segments 14 and/or movement of the rotatable part 16.

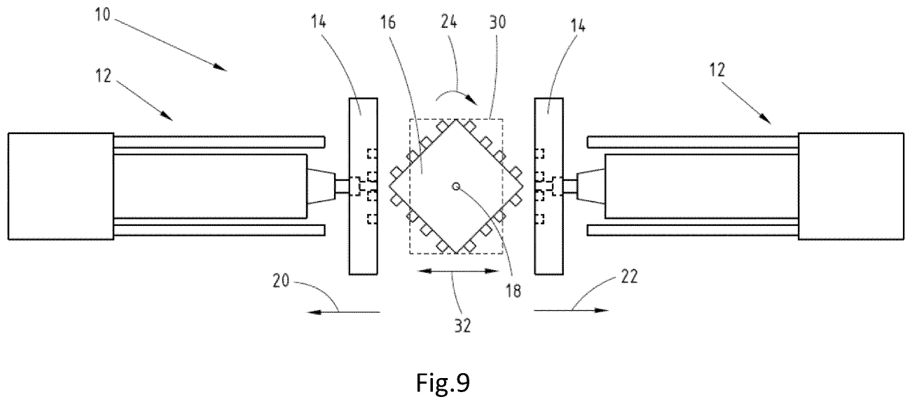

In FIG. 9, the segments 14 move further in the directions 20, 22, the table moves in the direction 32, for example to left or right, and the rotatable part 16 moves in the direction 24, for example clockwise.

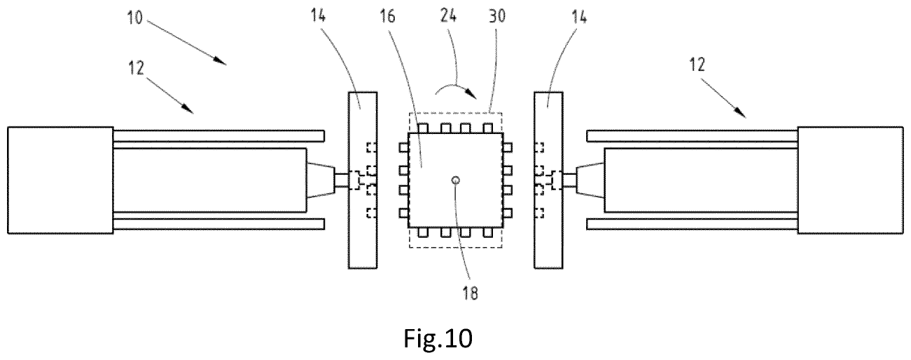

In FIG. 10, the movements of the segments 14, the table 30 and the rotatable part 16 are at an end. The rotatable part 16 is rotated by 90° in FIG. 10 in relation to the position in FIG. 6. In principle, any desired rotations about any desired axes of rotation and/or angles are conceivable, for example about 90°, 180°, 270° or 360°.

In a further preferred exemplary embodiment, the movements of the at least one segment 14, the table 30 and/or the rotatable part 16 are at least partly coupled to one another. Thus, the movements are preferably dependent on one another. For example, it is conceivable for movement of the table 30 to start only after a certain period of movement of the segment 14 and/or as soon as the segment 14 has reached a certain position. It is likewise conceivable for movement of the rotatable part 16 only to be started when the table 30 and/or the segment 14 have reached a certain position and/or have been moving for a certain period.

In a further preferred exemplary embodiment, it is also possible for the coupling to be in a staggered sequence. For example, there is first a wait until the segment 14 has reached a certain position and/or has been moved for a certain period. Then, movement of the table 30 is started. There is then likewise a wait before the start of movement of the rotatable part 16, until the segment 14 and/or the table 30 have reached a certain position and/or have been moved for a certain period. In a further preferred exemplary embodiment, movement of the table 30 is coupled to movement of the segment 14 until an overlapped braking function starts up and the table 30 is slowed down to reach its final position for this work step.

In a further preferred exemplary embodiment, movement of the table 30 in relation to movement of the at least one segment 14 is multiplied by a factor of less than or equal to one, preferably a factor of 0.1, 0.2, 0.3, 0.4, 0.5, 0.6, 0.7, 0.8, 0.9 or 1.0. For example, the segment 14 and the table 30 start their movement simultaneously, for example to the left in the direction 20. However, movement of the table is multiplied by a factor of less than or equal to one, with the result that the change in position of the table 30 is smaller than the change in position of the segment 14. Advantageously, the table 30 and hence the rotatable part 16 track the segment 14 but are unable to collide. Thus, during this movement the rotatable part 16 moves away from the segment 14. If, in a further exemplary embodiment, for example two segments 14 are provided, the rotatable part 16 moves away from both segments 14. Preferably, the growing spacing is identical on both sides.

In a further preferred exemplary embodiment, the coupling is carried out in electrical and/or mechanical manner. For example, it is conceivable for the segment 14, the table 30 and/or the rotatable part 16 to be coupled by way of a mechanical shaft, as a result of which security in respect of the movements made is advantageously enhanced. With an electrical coupling, for example the positions of the segment 14, the table 30 and the rotatable part 16 may be detected. With an appropriately predetermined position, the respective movements are then performed such that advantageously a simple and rapid coupling can be performed, in particular when replacing the rotatable part 16. Also conceivable is a mixed coupling. For example, the segment 14 could be coupled to the table 30 by a mechanical coupling such as a rack, and coupling to the rotatable part 16 could be electronic.

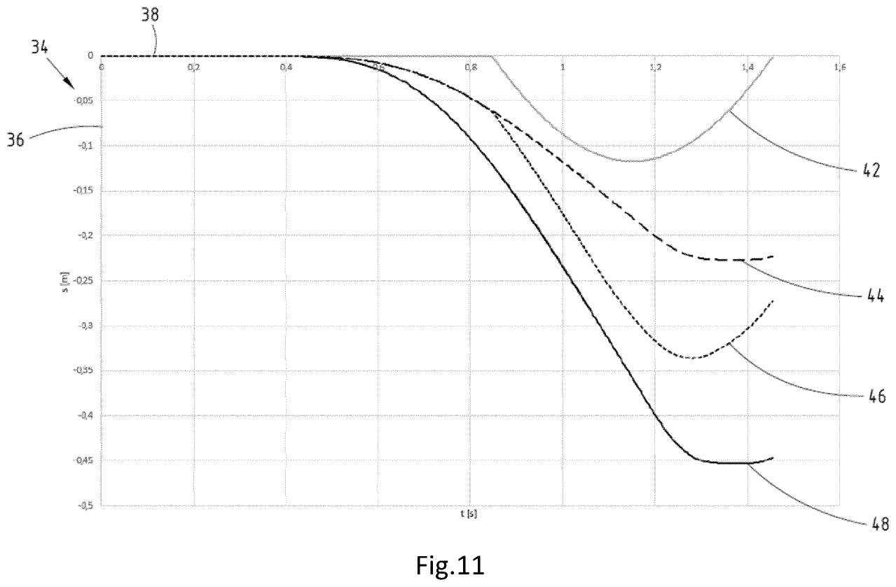

FIG. 11 illustrates a graph 34 for a further exemplary embodiment, wherein an axis 36, for example distance in meters, is plotted over a further axis 38, for example time in seconds. A curve 48 charts the position and/or the distance traveled by the at least one segment 14 at a certain point in time. For example, the distance corresponds to a value of approximately −0.45 after approximately 1.3 seconds. The values of the axes 36, 38 in this case are to be understood as purely exemplary. A curve 44 charts the translational movement of the rotatable part 16 as a result of movement of the movable table 30. It can be seen from this that there is for example a factor of approximately 0.5 between movement of the movable table 30, that is the curve 44, and the at least one segment 14, that is the curve 48. A curve 42 charts the movement of the rotatable part 16, for example along the x coordinate. A curve 46 illustrates the overlapped movement of the rotatable part 16 with the movable table 30, for example along the x coordinate. The curve 46 is obtained by summing the curves 44 and 42. It can be seen that at first only the movable table 30 moves until, approximately at a time point at 0.85 seconds, movement of the rotatable part 16 along the x coordinate begins. In FIG. 11, the rotatable part 16 only performs its movement once the gap between the rotatable part 16 and the segment 14 is large enough for the rotatable part 16 to fit into the gap even in the least favorable case, for example with a rotation about 45°, and not to collide. A corresponding situation also applies for example to movement of the rotatable part along a different coordinate, for example the y or the z coordinate.

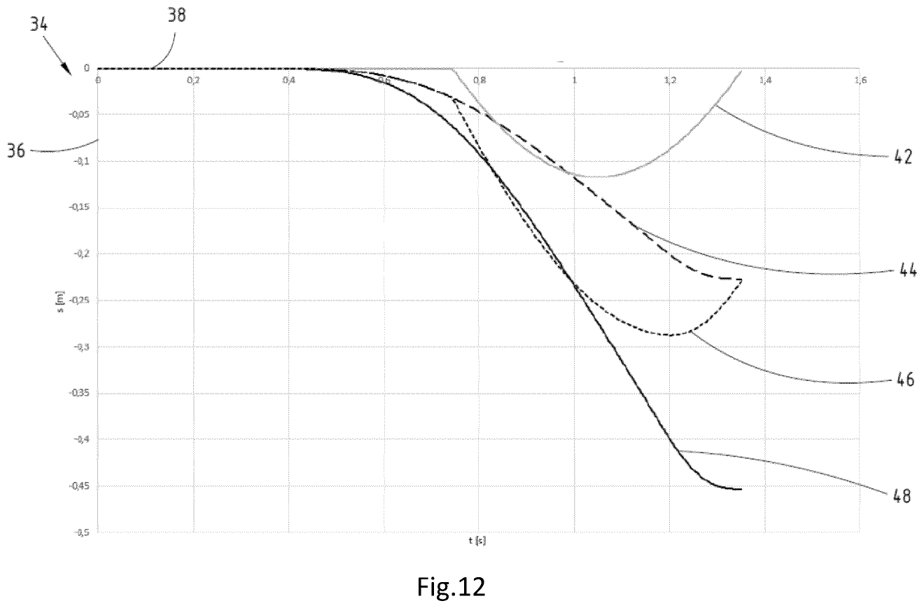

In a further exemplary embodiment, in FIG. 12, and in contrast to FIG. 11, movement of the rotatable part 16 already begins after approximately 0.75 seconds, as a result of which advantageously a shorter cycle time is produced. For example, the time shown in curve 42 for movement of the rotatable part in FIG. 12 is less than 1.4 seconds, while the time in FIG. 11 is greater than 1.4 seconds. Because the other parameters in FIG. 12, such as speeds of movement and/or rotation, correspond to the parameters in FIG. 11, in FIG. 12 movement of the rotatable part 16 already takes place at a point in time at which the gap between the rotatable part 16 and the segment 14 is not yet large enough, in the least favorable case, for example at a rotation of 45°, to prevent a collision. Collision is preferably prevented by the fact that, during movement of the rotatable part 16, the segment 14 is moved further and thus the gap between the rotatable part 16 and the segment 14 is made larger, such that when the least favorable case is reached the gap is large enough.

In a further preferred exemplary embodiment, movement of the rotatable part 16, for example rotation, is only started once the spacing between the segment 14 and the rotatable part 16 is greater than a molded part height 29. The molded part height 29 corresponds to the dimension by which the preferably completely demolded molded part projects out of the rotatable part 16. If, for example in the case of two segments 14, the molded part height 29, as the spacing relative to the rotatable part 16, is exceeded on both sides then movement of the rotatable part 16 is initiated. The rotatable part 16 begins to rotate while movement of the table 30 and/or the segments 14 is simultaneously performed.

In a further preferred exemplary embodiment, movement of the at least one segment 14, the part 16 and/or the table 30 is position-controlled. For example, the position control may be carried out using a servo-electrical and/or servo-hydraulic drive such as a direct drive or a piston system.

Typically, there is no linear relationship between a drive, such as an angle of rotation of a motor, and a corresponding movement of the at least one segment 14, the part 16 and/or the table 30. In a further preferred exemplary embodiment, for position control movements of the at least one segment 14, the part 16 and/or the table 30 are linked by a mathematical function in order advantageously to produce a mold movement that is as fast and efficient as possible. In a further preferred exemplary embodiment, the mathematical function takes the kinematics of the corresponding drive into account. For example, in the case of a servo-electrical drive, the angle of rotation of the motor and the linear movement of the movable platen do not have a linear relationship. In order advantageously to produce movement that is as efficient as possible, the desired pattern of movement is linked by a mathematical function with the kinematics of the drive.

In a further preferred exemplary embodiment, movement of the part 16 in at least one angular position about the axis of rotation 18 is position-controlled along a rotational collision curve. For example, a mathematical function that describes the diagonal of the cube mold along the rotational movement is stored.

In a further preferred exemplary embodiment, the rotational collision curve is dependent on at least one parameter of the part, such as the edge length 28 of the rotatable part 16 and/or the molded part height 29.

In a further preferred exemplary embodiment, the parameters of edge length of the rotatable part and molded part height may be input and/or taught to the controller. Teaching advantageously produces enhanced security, since in this way no collision can occur.

Frequently, the machine 10 also has further peripheral systems such as a robot system and/or a gripper, by which for example the molded parts are removed. In a further preferred exemplary embodiment, the movement of at least one peripheral system, such as a robot system, is at least partly coupled to movements of the at least one segment, the table and/or the part. As a result, delays are avoided and the cycle time is further shortened. For example, by integrating the controller of a robot system, the movement sequences of the robot system may likewise be coupled to movements of the table 30 and/or movement of the rotatable part 16.

A machine 10 for processing plastics and other plasticizable materials, in particular an injection molding machine, is disclosed in a further exemplary embodiment which takes a form, is configured and/or is set up to carry out at least one of the methods described above, while achieving the said advantages.

A further exemplary embodiment is formed by a computer program product with a program code that is stored on a computer-readable medium, for the purpose of carrying out at least one of the methods described above, while achieving the said advantages.

It goes without saying that this description may be subject to the most diverse modifications, changes and adaptations which are within the range of equivalents to the attached claims.

### LIST OF REFERENCE NUMERALS

10 Machine
12 Injection unit
14 Segment
16 Rotatable part
18 Axis of rotation
20 Direction
22 Direction
24 Direction
28 Edge length
29 Molded part height
30 Movable table
32 Direction
34 Graph
36 Axis
38 Axis
42 Curve
44 Curve
46 Curve
48 Curve

1. A method for rotating a rotatable part (16) about at least one axis of rotation (18) of a machine (10) for processing plastics and other plasticizable materials, in particular an injection molding machine, having at least one movable segment (14) for the manufacture of at least one molded part, wherein movement of the at least one segment (14) is at least partly overlapped by movement of the rotatable part (16), wherein movement of the rotatable part (16) is started when the spacing between the at least one segment (14) and the rotatable part (16) is greater than a molded part height of a molded part that is to be manufactured on the machine (10).

2. The method as claimed in claim 1, characterized in that the rotatable part (16) is mounted on and/or on top of a movable table (30), and movement of the table (30) is at least partly overlapped by movement of the at least one segment (14) and/or movement of the rotatable part (16).

3. The method as claimed in one of the preceding claims, characterized in that the movements of the at least one segment (14), the movable table (30) and/or the rotatable part (16) are at least partly coupled to one another.

4. The method as claimed in claim 2 or 3, characterized in that movement of the movable table (30) in relation to movement of the at least one segment (14) is multiplied by a factor of less than or equal to one, preferably a factor of 0.5.

5. The method as claimed in claim 3 or 4, characterized in that the coupling is carried out electrically and/or mechanically.

6. The method as claimed in one of the preceding claims, characterized in that movement of the at least one segment (14), the rotatable part (16) and/or the movable table (30) is position-controlled.

7. The method as claimed in claim 6, characterized in that for position control movement of the at least one segment (14), the rotatable part (16) and/or the movable table (30) is linked by at least one mathematical function.

8. The method as claimed in claim 6 or 7, characterized in that movement of the rotatable part (16) in at least one angular position about the axis of rotation (18) is position-controlled along a rotational collision curve.

9. The method as claimed in claim 8, characterized in that the rotational collision curve is dependent on at least one parameter of the rotatable part (16).

10. The method as claimed in claim 9, characterized in that the at least one parameter of the rotatable part (16) is taught.

11. The method as claimed in one of the preceding claims, characterized in that the movement of at least one peripheral system is at least partly coupled to movements of the at least one segment (14), the movable table (30) and/or the rotatable part (16).

12. A machine (10) for processing plastics and other plasticizable materials, in particular an injection molding machine, characterized in that the machine (10) takes a form, is configured and/or is set up to carry out the method as claimed in one of claims 1 to 11.

13. A computer program product with a program code that is stored on a computer-readable medium, for the purpose of carrying out the method as claimed in one of claims 1 to 11.
